(19) United States
(12) Patent Application Publication
(10) Pub. No.: US 2026/0184386 A1
(43) Pub. Date: Jul. 2, 2026

(54) HINGE SYSTEM AND A METHOD FOR MOUNTING A TAILGATE TO A DUMP TRAILER

(71) Applicant: Terrence Michael Stulc, Stevensville, MT (US)

(72) Inventor: Terrence Michael Stulc, Stevensville, MT (US)

(21) Appl. No.: 19/548,319

(22) Filed: Feb. 24, 2026

Related U.S. Application Data
(60) Provisional application No. 63/738,819, filed on Dec. 25, 2024.

(51) Int. Cl. B62D 33/03; B62D 33/033; E05D 3/02; E05D 3/06; E05D 5/04; E05D 7/10; E05D 15/522

(52) U.S. Cl. CPC B62D 33/03; B62D 33/033; E05D 3/02; E05D 3/06; E05D 5/043; E05D 7/1005; E05D 15/522; E05D 2007/1027

(57) ABSTRACT

A hinge system for mounting a tailgate to a vehicle, particularly a dump trailer, is disclosed. The system includes at least one three-leaf hinge having a middle leaf positioned between left and right leaves, and at least one two-leaf hinge. Each hinge includes interleaved knuckles defining a pin-receiving axis, with at least one removable hinge pin configured to selectively couple adjacent leaves. The hinge system enables a tailgate to be reconfigured between multiple operational modes including lateral swinging, upward tilting, downward tilting for ramp use, partial opening for material spreading, and complete removal from the vehicle. The hinge pins may include retention features and the knuckles may incorporate reinforcement or wear-reduction elements for heavy-load applications. Selective removal of hinge pins permits rapid reconfiguration of the tailgate without specialized tools. The disclosed hinge system provides enhanced durability, versatility, and ease of use compared to conventional fixed tailgate hinge arrangements.

### CROSS REFERENCE TO RELATED APPLICATIONS

This application claims priority to U.S. Provisional Patent Application No. 63/738,819, filed Dec. 25, 2024, the entirety of which is incorporated herein by reference.

### FIELD OF INVENTION

The present invention relates generally to hinges, and more particularly to a hinge system having a removable pin, suitable for mounting tailgates to trailers.

### BACKGROUND

Dump Trailers equipped with tailgates are widely used for transporting objects and materials. For example, dump trailers are commonly employed in construction, landscaping, agriculture, and similar industries. A tailgate typically comprises a panel closing the rear end of an open-box dump trailer. The tailgate is hingedly coupled to the trailer bed or trailer frame and may be mounted in various configurations to permit different opening motions. In dump trailers, the tailgate is often configured to swing upward about upper hinges and, in some cases, to fold downward about lower hinges. Tailgates incorporating hydraulic opening and closing mechanisms are also known.

Existing tailgate hinge configurations present numerous drawbacks, particularly during unloading operations. Tailgates frequently become damaged while dumping, as they obstruct or resist the flow of discharged material. Conventional tailgates are typically permanently mounted and cannot be readily removed when not needed. Furthermore, traditional tailgate designs provide limited functionality and generally cannot be repurposed for alternative uses, such as controlled material spreading or serving as a loading ramp.

Accordingly, there exists a need for an improved hinge system for mounting tailgates to dump trailers in a more versatile and efficient manner. In particular, there is a need for a hinge system that permits rapid removal and reinstallation of a tailgate, enhances durability during dumping operations, and expands the functional utility of the tailgate, especially in dump trailer applications.

### SUMMARY OF THE INVENTION

The following presents a simplified summary of one or more embodiments of the present invention to provide a basic understanding of certain features and advantages thereof. This summary is not an exhaustive overview of all contemplated embodiments and is not intended to identify key or critical elements of the invention or to delineate the scope of the claims. Rather, it introduces selected concepts that are further described in the detailed description.

A principal object of the present invention is to provide a hinge system for mounting a tailgate to a dump trailer that enables the tailgate to swing open, tilt upward, tilt downward, and selectively function as a ramp.

Another object of the present invention is to reduce or prevent damage to the tailgate during dumping operation.

Another object of the present invention is to enable rapid and convenient removal and reinstallation of the tailgate.

Yet another object of the present invention is to provide a hinge system that is simple in construction and economical to manufacture.

The present invention provides a hinge system and vehicle tailgate assembly that overcomes limitations of conventional fixed tailgate hinge arrangements. In particular, the invention enables a tailgate to be selectively reconfigured between multiple operational modes including lateral swinging, upward tilting, downward tilting for ramp use, partial opening for controlled material discharge, and complete removal from the vehicle.

In one aspect, the invention provides a hinge assembly comprising at least one hinge joint that has hinge members with interleaved knuckles defining a pin-receiving axis and at least one removable hinge pin configured to pivotally couple the hinge members. Selective removal of the removable hinge pin permits rapid reconfiguration or removal of the tailgate without specialized tools.

In another aspect, the invention provides a three-leaf hinge including a middle leaf positioned between a left leaf and a right leaf, wherein the middle leaf includes knuckles on opposite sides thereof defining first and second pin-receiving axes. Separate hinge pins are provided on each side of the middle leaf, and one or both of the hinge pins may be removable to enable independent separation and reconfiguration of the tailgate.

In further aspects, the hinge assembly may additionally include one or more two-leaf hinges cooperating with the three-leaf hinge to permit upward tilting, downward tilting, lateral swinging, ramp operation, spreader gate operation, and complete tailgate removal.

The invention further provides a dump trailer having a box body open at a rear end and a tailgate mounted thereto using the disclosed hinge assembly. In certain embodiments, the tailgate includes first and second tailgate members selectively securable together and independently swingable relative to the box body.

The hinge joints may include removable pins that have retention features, and knuckles may incorporate reinforcement or wear-reduction elements for heavy-load dumping applications. The hinge components may be fabricated from corrosion-resistant materials.

Advantageously, the disclosed system improves durability during dumping operations, reduces tailgate damage, permits rapid installation and removal, and substantially increases the functional versatility of vehicle tailgates as compared to conventional fixed hinge configurations.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 illustrates a perspective view of a hinge system, according to an exemplary embodiment of the present invention.

FIG. 2 illustrates an alternate perspective view of the hinge system, according to an exemplary embodiment of the present invention.

FIG. 3 illustrates a removable pin of the hinge system, according to an exemplary embodiment of the present invention.

FIG. 4 illustrates the hinge system comprising first and second hinge leaves and the removable pin, according to an exemplary embodiment of the present invention.

FIG. 5 illustrates a side perspective view of a dump trailer having a tailgate mounted using the hinge system, according to an exemplary embodiment of the present invention.

FIG. 6 illustrates an enlarged rear view of the dump trailer shown in FIG. 5, according to an exemplary embodiment of the present invention.

### DETAILED DESCRIPTION

The subject matter of the present invention will now be described more fully with reference to the accompanying drawings, which form a part of this disclosure and illustrate specific exemplary embodiments. However, it should be understood that the subject matter may be embodied in various forms and is not limited to the specific embodiments set forth herein. Rather, these embodiments are provided by way of example to convey the scope of the invention. It is intended that the claims encompass a broad range of subject matter, including methods, devices, components, and systems. Accordingly, the following detailed description is not intended to be taken in a limiting sense.

As used herein, the term “exemplary” is intended to mean “serving as an example, instance, or illustration.” Any embodiment described as “exemplary” should not be construed as preferred or more advantageous over other embodiments. Similarly, the expression “embodiments of the present invention” does not imply that all embodiments must include all features, advantages, or modes of operation described.

The terminology used herein is for the purpose of describing particular embodiments only and is not intended to be limiting. As used herein, the singular forms “a,” “an,” and “the” include plural references unless the context clearly dictates otherwise. Furthermore, the terms “comprises,” “comprising,” “includes,” and/or “including” specify the presence of stated features, integers, steps, operations, elements, or components, but do not preclude the presence or addition of one or more other features, integers, steps, operations, elements, components, and/or groups thereof.

The following detailed description sets forth the best currently contemplated modes for carrying out exemplary embodiments of the invention. This description is not intended to be limiting, but rather to illustrate the general principles of the invention. The claims of any issued patent will define the scope of the invention.

The invention described herein pertains to a hinge system for mounting a tailgate to trailers, and particularly to dump trailers. The disclosed hinge system enables the tailgate to be selectively configured to swing open in multiple directions. More specifically, the hinge system allows the tailgate to tilt upward out of the way during dumping, tilt downward for use as a ramp, function as a spreader gate, or be removed entirely. A removable pin mechanism permits rapid installation and removal of the tailgate. The system provides substantial operational flexibility. In exemplary embodiments, the hinge system includes a combination of three-leaf hinges and two-leaf hinges, wherein at least one three-leaf hinge includes a removable pin.

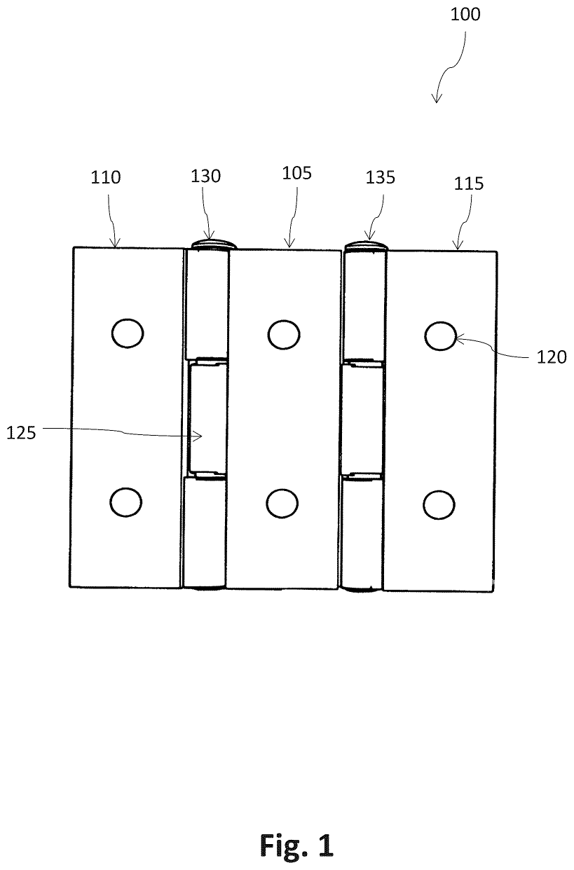

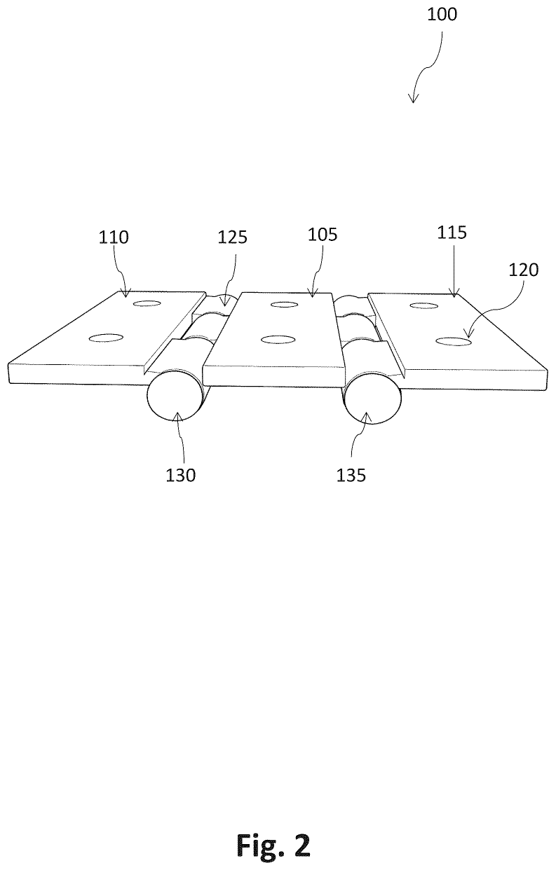

Referring to FIGS. 1 and 2, a hinge system 100 is illustrated comprising three leaves, namely a middle leaf 105, a left leaf 110, and a right leaf 115. The middle leaf 105 includes knuckles on both lateral sides and further includes countersunk holes 120 configured to receive fasteners for securing the middle leaf to a mounting structure.

The left leaf 110 includes knuckles 125 along its right edge, which interleave with corresponding knuckles of the middle leaf 105 to receive a left pin 130. The left pin 130 may be removably inserted through the aligned knuckles to pivotally couple the left leaf to the middle leaf. Removal of the left pin permits detachment of any component mounted to the left leaf. The head of the left pin may be enlarged to facilitate manual gripping. The left pin may further include a fastening mechanism, such as threads, a threaded end with nut, or other suitable retention structure. Any fastening configuration capable of securing the pin within the knuckles is within the scope of the present invention. The left leaf additionally includes countersunk openings for receiving mounting fasteners.

Similarly, the right leaf 115 includes knuckles 125 along its left edge which interleave with knuckles on the opposite side of the middle leaf 105 to receive a right pin 135. The right pin 135 may likewise be removable and may include an enlarged head and fastening mechanism analogous to the left pin. Removal of the right pin permits separation of components mounted to the right leaf. Any suitable retention mechanism for the right pin is contemplated.

As used herein, each “knuckle” refers to a tubular or partially tubular hinge barrel segment formed along an edge of a hinge leaf. The knuckles of adjacent hinge leaves are arranged in an alternating, interleaved configuration so as to define a continuous axial passage configured to receive a hinge pin.

In exemplary embodiments, each hinge leaf includes a plurality of longitudinally spaced knuckles. When assembled, the knuckles of the middle leaf interleave with corresponding knuckles of the left or right leaf, thereby forming a pivot joint about the axis defined by the inserted hinge pin.

The knuckles may be integrally formed with their respective hinge leaves or may be separately manufactured and subsequently welded, brazed, riveted, or otherwise secured to the leaves.

Each knuckle defines an internal bore sized to receive the hinge pin with a clearance fit, sliding fit, or interference fit depending on the desired operational characteristics. In certain embodiments, the internal bore may include threading, detents, grooves, or locking features configured to cooperate with corresponding features on the hinge pin.

The number, length, diameter, spacing, and wall thickness of the knuckles may be varied to accommodate different load requirements, tailgate sizes, or vehicle configurations without departing from the scope of the present invention.

In some embodiments, one or more knuckles may include reinforcing collars, bushings, or sleeves to reduce wear and increase durability under repeated opening cycles and heavy loading conditions.

The knuckles may be cylindrical, polygonal, or partially enclosed in cross-section, and may be aligned coaxially or with intentional offsets to provide controlled pivot angles or stepped motion.

Although illustrated as continuous tubular segments, the knuckles may alternatively be implemented as segmented barrels, partially open loops, or articulated hinge elements, provided they collectively define a pin-receiving axis enabling pivotal movement between hinge leaves.

In certain embodiments, the hinge system is configured for heavy-load applications such as dump trailer tailgates, wherein the knuckles are reinforced to withstand repeated impact forces, vibration, and material pressure during dumping operations.

Reinforcement may include increased wall thickness of the knuckles, enlarged pin diameters, hardened steel sleeves, or internal bushings positioned within one or more knuckles to reduce metal-to-metal wear.

In some implementations, low-friction liners, polymer bushings, or bearing inserts are positioned within the knuckles to facilitate smooth pivoting while minimizing corrosion and abrasion.

The hinge pins may be fabricated from hardened steel, stainless steel, or coated alloys, and may include surface treatments such as nitriding, galvanizing, or anti-corrosion coatings.

The hinge leaves may further include gussets, ribs, or thickened regions adjacent the knuckles to distribute loads into the mounting surfaces.

In certain embodiments, the removable hinge pins include secondary retention features to prevent accidental disengagement during vehicle operation. Such retention features may include spring-loaded detents, locking balls, cotter pins, snap rings, clips, threaded collars, safety chains, or tether cables.

In some embodiments, the hinge pin includes a transverse aperture configured to receive a retaining clip after insertion.

In further embodiments, the hinge pin head may be magnetically retained against a hinge leaf or include a locking collar requiring deliberate user actuation for removal.

These safety features ensure that the hinge pins remain secured under vibration while still permitting intentional manual removal.

The knuckles may be arranged symmetrically or asymmetrically along hinge leaves, and may vary in length, spacing, or quantity to accommodate different tailgate sizes and mounting geometries.

In certain embodiments, alternating knuckles are positioned on opposite leaves such that load forces are evenly distributed across the hinge joint.

The knuckles may include internal stops or external shoulders to limit angular travel of the hinge.

In further embodiments, the knuckles may be replaceable modules attachable to hinge leaves.

All such knuckle configurations that define a pivot axis receiving a removable pin are considered within the scope of the present invention.

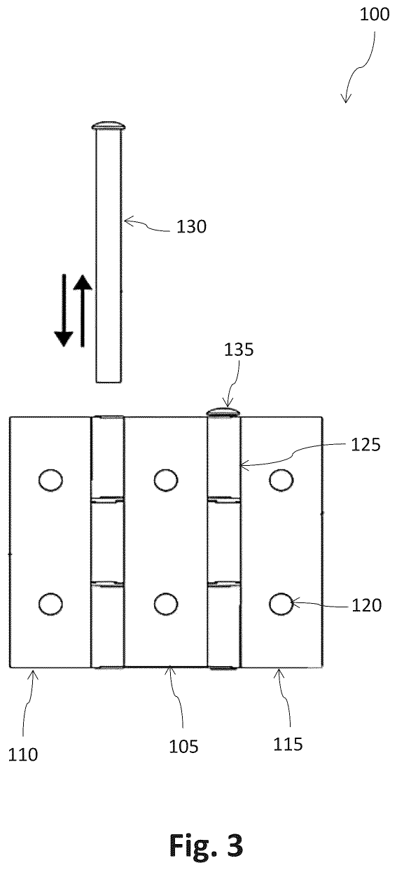

In certain embodiments, both the left pin and the right pin are removable. In other embodiments, only one of the pins is removable. FIG. 3 illustrates the left pin 130 removed from the knuckles and aligned for reinsertion.

Also disclosed is an assembly including the three-leaf hinge system 100 in combination with a two-leaf hinge system 200. These hinge systems may be used in various combinations to permit multiple tailgate configurations and complete removal of the tailgate.

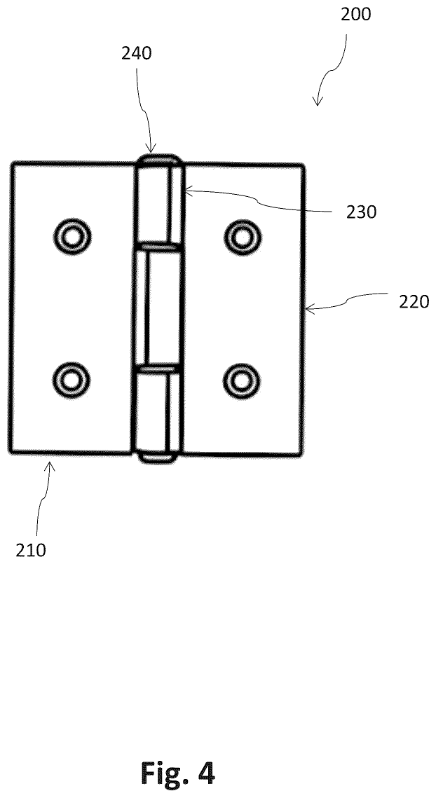

FIG. 4 illustrates the two-leaf hinge system 200 comprising a first leaf 210 and a second leaf 220, each having corresponding knuckles 230 that inter-engage and receive a removable hinge pin 240. The hinge pin 240 may also include an enlarged head and fastening mechanism.

In certain embodiments, the pin head may include an engagement slot adapted to receive a tool for assisted removal. For example, a rod-type tool may be inserted into the slot and rotated to engage and extract the pin.

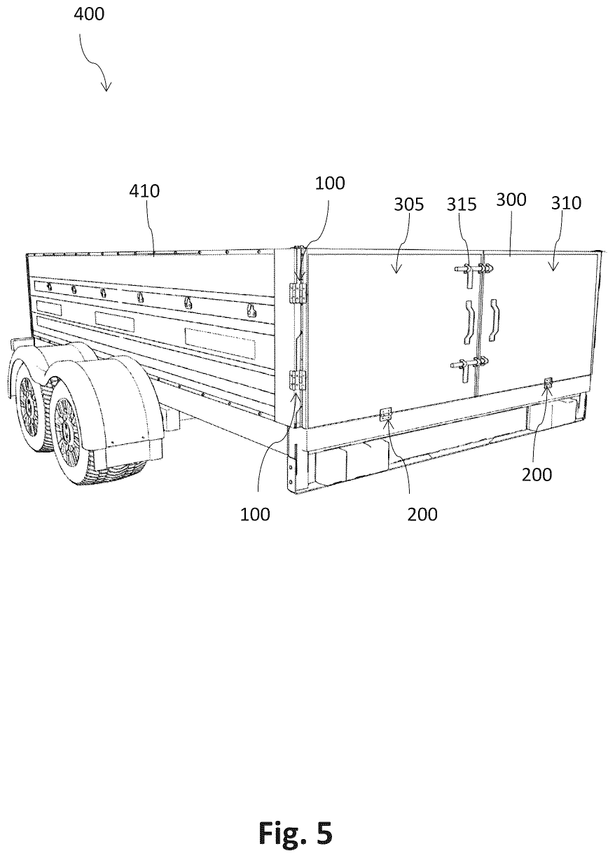

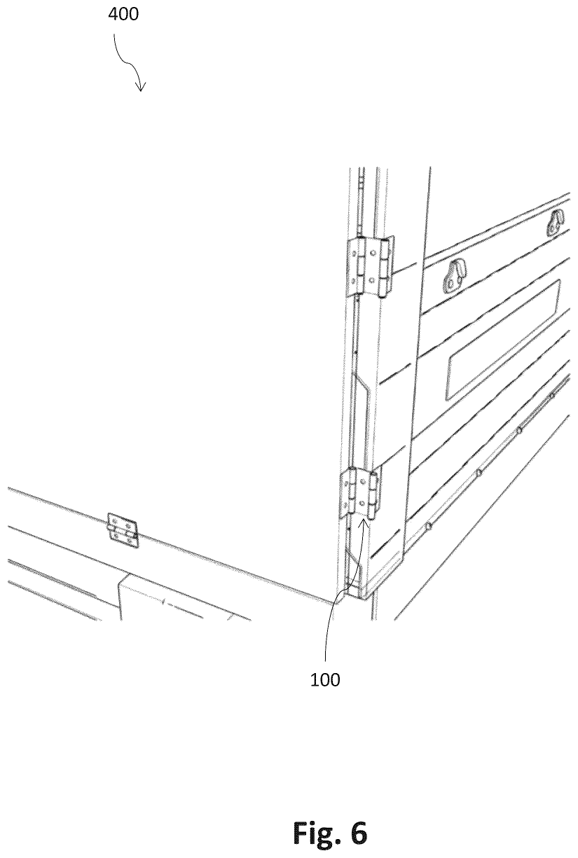

Referring to FIGS. 5 and 6, the disclosed hinge assembly is shown mounting a tailgate to a box body of a dump trailer. The three-leaf hinge system 100 is mounted alongside portions of the tailgate, while the two-leaf hinge system 200 is mounted along a lower portion of the tailgate. Either or both hinge systems may be used in any suitable combination. Although described in connection with dump trailers, the disclosed hinge systems may be used in other applications without departing from the scope of the invention.

As more clearly illustrated in FIG. 6, the left leaf and middle leaf are mounted to an end column of the box body wall, with the left leaf secured to a lateral face of the column and the middle leaf secured to a forward face thereof. The right leaf is mounted to the tailgate.

A tailgate 300 is further disclosed, comprising a left member 305 and a right member 310. Each member may include handles and one or more locking mechanisms 315 for selectively securing the members together. Preferably, at least two locks are spaced apart to enhance stability when the tailgate is opened. The left member may swing outward on the left side, and the right member may swing outward on the right side.

Also disclosed is a trailer 400 having a box body 410 open at a rear end, with tailgate 300 mounted thereto using the disclosed hinge assembly comprising hinge joints 100 and 200.

In certain embodiments, two or more three-leaf hinges 100 mount each tailgate member to respective sidewalls, while one or more two-leaf hinges 200 mount each tailgate member to a base of the box body. Alternatively, the two-leaf hinges may be mounted to an upper transverse bar, enabling upward swinging of the tailgate.

In operation, removal of selected hinge pins enables reconfiguration between sideward swing, downward swing, upward swing, or complete removal. For example, removing pins from bottom hinges permits lateral opening, while removing side hinge pins permits downward opening. Removal of all pins allows complete tailgate detachment.

Also disclosed is a method of mounting a tailgate to a trailer using the hinge assembly described herein. While a two-member tailgate is illustrated, a single-piece tailgate may likewise be employed.

The hinges may be manufactured from any suitable material, preferably corrosion-resistant metals such as stainless steel. Dimensions, knuckle count, hole placement, and hinge length may be varied depending on application requirements without departing from the scope of the invention.

In exemplary operation, the disclosed hinge assembly enables a plurality of tailgate configurations by selective removal and insertion of hinge pins.

In a side-swing mode, hinge pins associated with the two-leaf hinges mounted along a bottom edge of the tailgate are removed, while hinge pins associated with the three-leaf hinges mounted alongside edges remain engaged, thereby allowing one or both tailgate members to swing laterally outward.

In a downward-tilt mode, hinge pins associated with the side-mounted three-leaf hinges are removed while hinge pins associated with the bottom-mounted two-leaf hinges remain engaged, permitting the tailgate to pivot downward and function as a loading ramp.

In an upward-tilt mode, hinge pins associated with side-mounted hinges are removed while hinge pins associated with upper-mounted hinges remain engaged, allowing the tailgate to pivot upward during dumping operations.

In a spreader-gate mode, one or more hinge pins are selectively removed to partially open the tailgate, thereby controlling discharge of material from the box body.

In a removal mode, hinge pins from both the three-leaf hinge system and the two-leaf hinge system are removed, permitting complete detachment of the tailgate from the trailer.

These operational modes may be achieved manually without specialized tools, or with simple engagement tools as described above, enabling rapid field reconfiguration by a single operator.

While exemplary embodiments illustrate combined use of three-leaf hinges and two-leaf hinges, alternative embodiments may employ only three-leaf hinges or only two-leaf hinges, depending on application requirements.

In certain embodiments, only side-mounted hinges are utilized, permitting lateral opening and full removal of the tailgate.

In other embodiments, only top-mounted or bottom-mounted hinges are utilized, permitting upward or downward pivoting, respectively.

In further embodiments, the removable pins may be spring-loaded, magnetically retained, tethered, or secured using detents, clips, cotter pins, threaded fasteners, or locking collars.

The hinge leaves may be straight, curved, offset, or stepped, and may include reinforcing ribs or gussets.

Although illustrated with a two-member tailgate, the disclosed hinge assembly may also be used with a single-panel tailgate.

The hinge assembly may further be adapted for use on trailers, utility vehicles, agricultural equipment, shipping containers, or any structure requiring multi-directional hinged panels.

In certain implementations, disclosed are a combination of different variety of hinges that are used in a pattern that allows for a very unique tailgate opening system and multi-functioning tailgate.

It is understood that dimensional variations, mounting locations, pin configurations, and material selections may be altered without departing from the spirit and scope of the present invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A hinge assembly comprising:
a three-leaf hinge including a middle leaf positioned between a left leaf and a right leaf,
wherein the middle leaf includes hinge knuckles on opposite sides thereof,
wherein the left leaf includes hinge knuckles configured to interleave with hinge knuckles on a first side of the middle leaf to define a first pin-receiving axis, and wherein the right leaf includes hinge knuckles configured to interleave with hinge knuckles on a second side of the middle leaf to define a second pin-receiving axis;
a first hinge pin receivable through the knuckles of the left leaf and the middle leaf; and
a second hinge pin receivable through the knuckles of the right leaf and the middle leaf;
wherein at least one of the first hinge pin or the second hinge pin is removable.

2. The hinge assembly of claim 1, further comprising a two-leaf hinge including a first leaf and a second leaf having interleaved knuckles defining a third pin-receiving axis, and a third hinge pin receivable through the knuckles of the two-leaf hinge.

3. The hinge assembly of claim 1, wherein either one of the first hinge pin and the second hinge pin is removable.

4. The hinge assembly of claim 1, wherein the third pin is removable.

5. The hinge system of claim 1, wherein the removable hinge pin includes a retention feature selected from the group consisting of threads, locking collars, spring detents, cotter pins, clips, snap rings, magnetic retainers, and tether members.

6. The hinge system of claim 1, wherein each of the hinge leaves include countersunk openings for receiving mounting fasteners.

7. A method of mounting and operating a tailgate on a vehicle, comprising:
mounting a three-leaf hinge between a sidewall of a vehicle box body and a lateral portion of a tailgate;
mounting a two-leaf hinge between the tailgate and a lower or upper portion of the vehicle box body;
inserting removable hinge pins through knuckles of the hinges to pivotally secure the tailgate; and
selectively removing at least one hinge pin to configure the tailgate between a lateral swing configuration, upward tilt configuration, downward tilt configuration, spreader configuration, or complete removal configuration.

8. A dump trailer, comprising:
a box body having sidewalls and an open rear end;
a tailgate mounted to the open rear end, the tailgate comprising a first tailgate member and a second tailgate member selectively securable together;
a plurality of hinge joints coupling the first tailgate member and the second tailgate member to the box body,
wherein at least one hinge joint includes a first hinge member and a second hinge member having interleaved knuckles defining a pin-receiving axis and a removable hinge pin insertable through the knuckles;
wherein selective removal of the removable hinge pin enables at least one of independent opening of the first and second tailgate members, downward tilting of the tailgate, upward tilting of the tailgate during dumping operations, partial opening for material discharge, or complete removal of the tailgate from the box body.
